(19) United States
(12) Patent Application Publication
(10) Pub. No.: US 2015/0271990 A1
(43) Pub. Date: Oct. 1, 2015

(54) Weeding Hand Tool Device

(71) Applicant: Phillip Tarantino, Banning, CA (US)

(72) Inventor: Phillip Tarantino, Banning, CA (US)

(21) Appl. No.: 14/224,141

(22) Filed: Mar. 25, 2014

(51) Int. Cl. A01D 1/06

(52) U.S. Cl. CPC A01D 1/06

(57) ABSTRACT

A weeding hand tool device facilitates removal of weeds using a sliding motion over the ground surface. The device includes a handle having a first end and a second end. The handle is elongated extending from the first end to the second end. A planar cutting head is coupled to the second end of the handle. The cutting head has a sharpened outer peripheral edge comprising a front section, a pair of outer front side sections, a rear section, and a pair of outer rear side sections. A pair of slots are aligned and extend inwardly from opposed sides of the cutting head wherein each slot is positioned between an associated one of the outer front side sections and an associated one of the outer rear side sections.

### BACKGROUND OF THE DISCLOSURE

### Field of the Disclosure

The disclosure relates to weeding tool devices and more particularly pertains to a new weeding tool device for facilitating removal of weeds using a sliding motion over the ground surface.

### SUMMARY OF THE DISCLOSURE

An embodiment of the disclosure meets the needs presented above by generally comprising a handle having a first end and a second end. The handle is elongated extending from the first end to the second end. A planar cutting head is coupled to the second end of the handle. The cutting head has a sharpened outer peripheral edge comprising a front section, a pair of outer front side sections, a rear section, and a pair of outer rear side sections. A pair of slots are aligned and extend inwardly from opposed sides of the cutting head wherein each slot is positioned between an associated one of the outer front side sections and an associated one of the outer rear side sections.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top back side perspective view of a weeding hand tool device according to an embodiment of the disclosure.

FIG. 2 is a partial top view of an embodiment of the disclosure.

FIG. 3 is a cross-sectional view of an embodiment of the disclosure taken along line 3-3 of FIG. 1.

FIG. 4 is a side view of an embodiment of the disclosure.

FIG. 5 is a top view of an alternative embodiment of the disclosure.

FIG. 6 is a top view of an alternative embodiment of the disclosure.

FIG. 7 is a top view of an alternative embodiment of the disclosure.

### DESCRIPTION OF THE PREFERRED EMBODIMENT

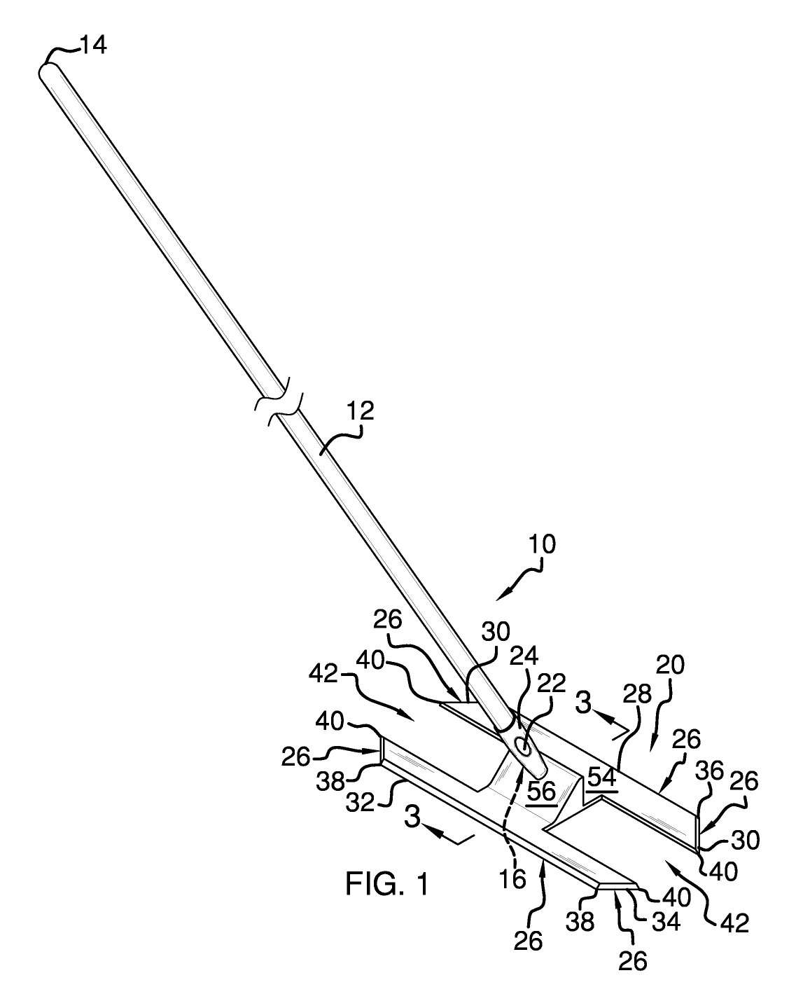

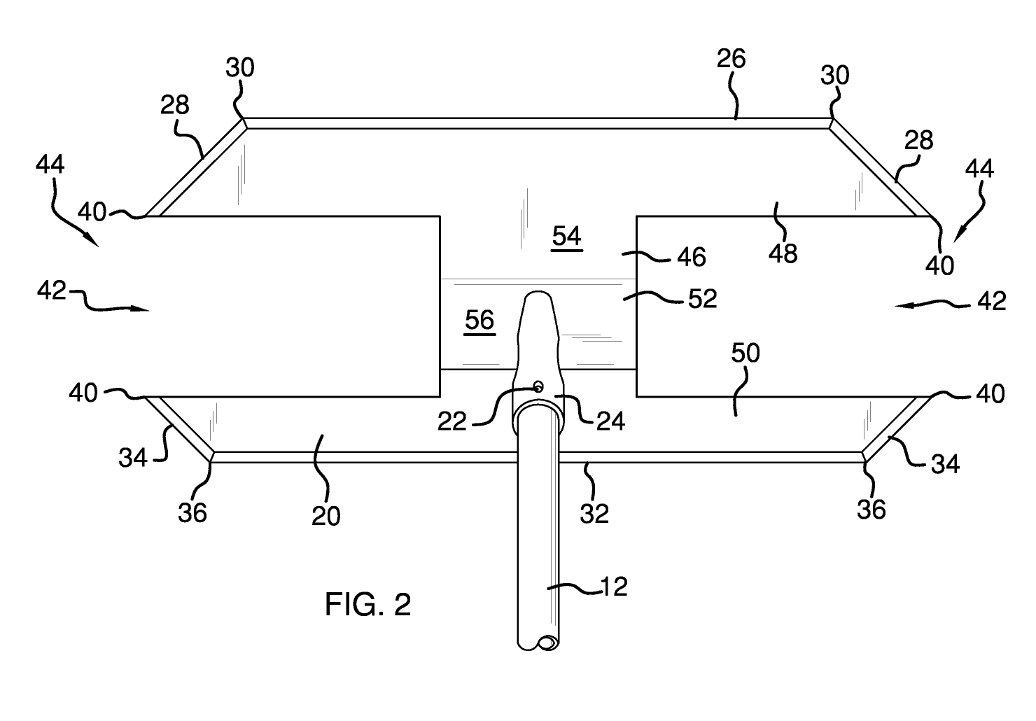

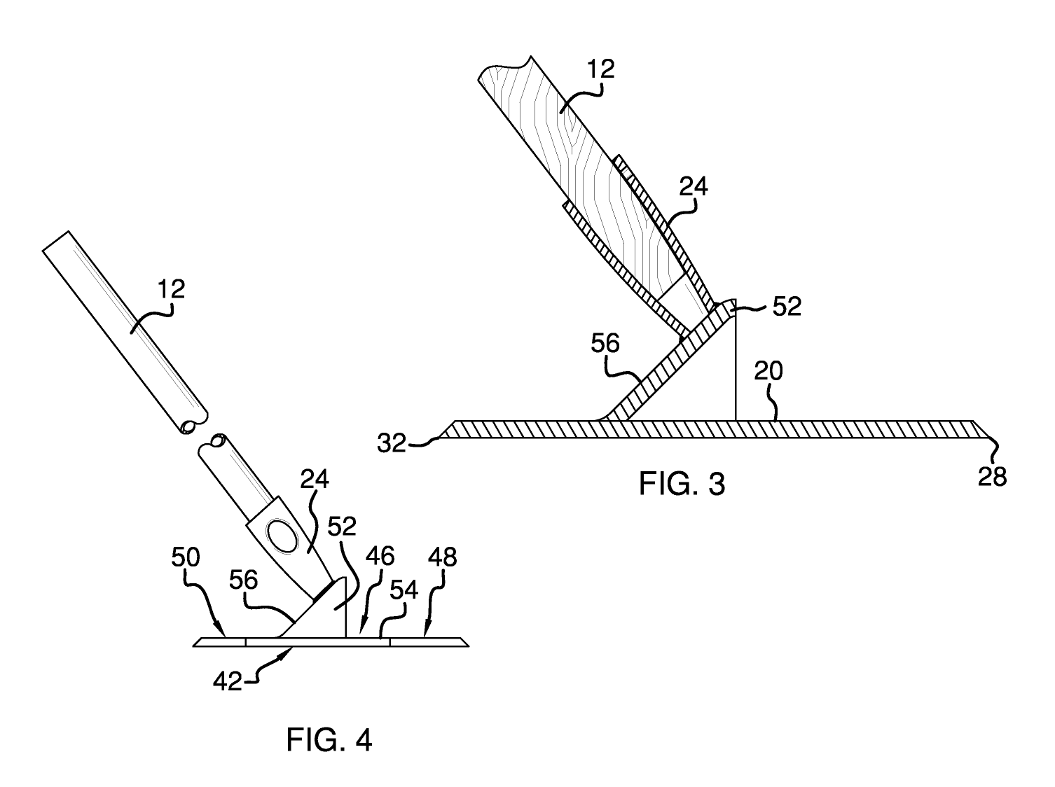

With reference now to the drawings, and in particular to FIGS. 1 through 7 thereof, a new weeding tool device embodying the principles and concepts of an embodiment of the disclosure and generally designated by the reference numeral 10 will be described.

As best illustrated in FIGS. 1 through 4, the weeding hand tool device 10 generally comprises a handle 12 having a first end 14 and a second end 16. The handle 12 is elongated extending from the first end 14 to the second end 16. The handle 12 may comprise a conventional wooden pole or the like. A cutting head 20 is coupled to the second end 16 of the handle 12. This may be achieved using a fastener 22 extending through a conventional collar 24 and into the handle 12. The cutting head 20 is planar. The cutting head 20 has a sharpened outer peripheral edge 26. The outer peripheral edge 26 includes a front section 28, a pair of outer front side sections 30, a rear section 32, and a pair of outer rear side sections 34. The front section 28 of the outer peripheral edge 26 is parallel to the rear section 32 and has a length greater than a length of the rear section 32 of the outer peripheral edge 26. Each of the outer front side sections 30 extends outwardly and rearwardly from an associated side 36 of the front section 28 of the outer peripheral edge 26. Each of the outer rear side sections 34 extends outwardly and forwardly from an associated side 38 of the rear section 32 of the outer peripheral edge 26. Respective distal ends 40 of the outer front side sections 28 and the outer rear side sections 34 may be transversely aligned relative to the front section 28 and the rear section 32.

Each of a pair of slots 42 extends into the cutting head 20. The slots 42 are aligned and extend inwardly from opposed sides 44 of the cutting head 20 wherein each slot 42 is positioned between an associated one of the outer front side sections 28 and an associated one of the outer rear side sections 34. The pair of slots 42 define a medial section 46 of the cutting head 20 between the slots 42. The medial section 46 of the cutting head 20 extends between a forward section 48 and a rearward section 50 of the cutting head 20. The second end 16 of the handle 12 is coupled to the medial section 46 of the cutting head 20. A base 52 is coupled to and extends upwardly from a top surface 54 of the cutting head 20. The second end 16 of the handle 12 is coupled to the base 52 such that the handle 12 extends outwardly from the base 52. The base 52 has an upper surface 56 which is angled to extend upwardly away from the top surface 54 of the cutting head 20 and forwardly towards the front section 28 of the outer peripheral edge 26. The handle 12 extends from the upper surface 56 of the base 52. The upper surface 56 of the base 52 is planar and the handle 12 is transverse to the upper surface 56 such that the handle 12 extends rearwardly and away from the top surface 54 of the cutting head 20.

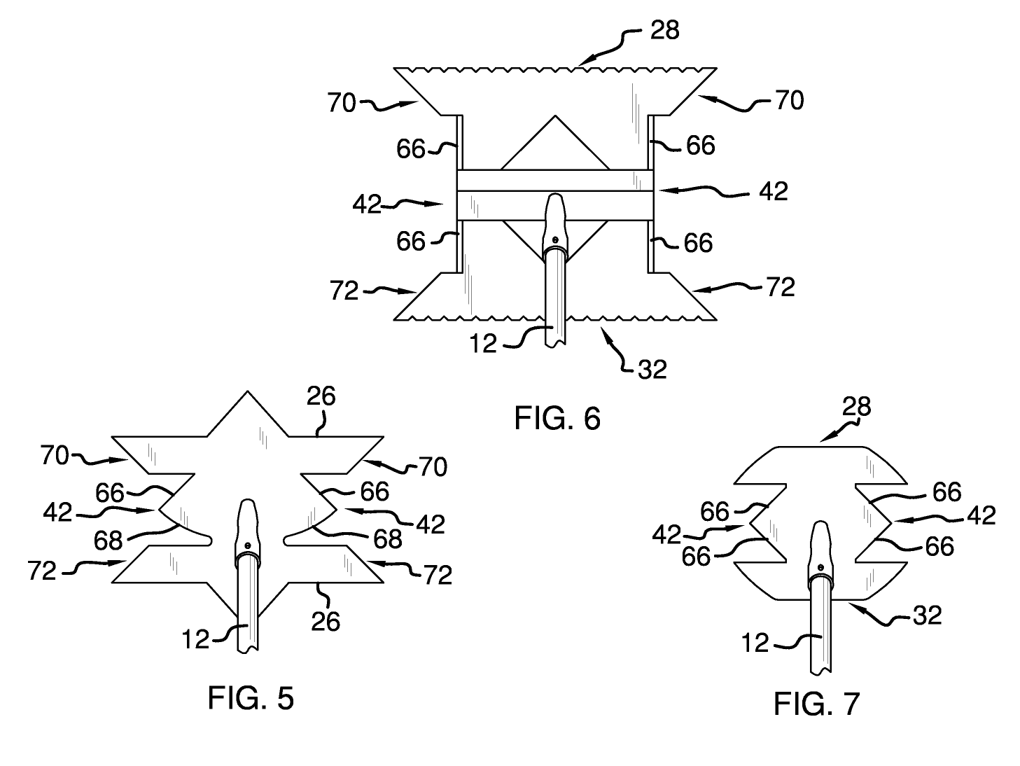

As shown in FIGS. 5 through 7, variations may be provided in the form of the cutting head 20. The outer peripheral edge 26 may have inwardly directed outer front side sections 70 and inwardly directed outer rear side sections 72, as shown in FIGS. 5 and 6. The front section 28 and rear section 32 may be serrated as shown in FIG. 6. Edges of the slots 42 may be sharpened and shaped to include various straight sections 66, as shown in FIG. 5, and curved sections 68, as shown in FIG. 7. Additionally, the outer front side sections 30 and outer rear side sections 34 may be curved as shown in FIG. 7. As shown in FIG. 5, triangular projections 70 may be centrally positioned extending respectively from the front section 28 and the rear section 32.

In use, the handle 12 is grasped to hold the cutting head 20 over or on a ground surface. The handle 12 is then manipulated to move the cutting head 20 substantially parallel to the ground surface permitting the outer peripheral edge 26 to cut weeds and other unwanted vegetation extending from the ground surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weeding hand tool device comprising:
a handle having a first end and a second end, said handle being elongated extending from said first end to said second end;
a cutting head coupled to said second end of said handle, said cutting head being planar, said cutting head having a sharpened outer peripheral edge, said outer peripheral edge comprising a front section, a pair of outer front side sections, a rear section, and a pair of outer rear side sections; and
a pair of slots extending into said cutting head, said slots being aligned and extending inwardly from opposed sides of said cutting head wherein each said slot is positioned between an associated one of said outer front side sections and an associated one of said outer rear side sections.

2. The device of claim 1, further comprising said front section of said outer peripheral edge having a length greater than a length of said rear section of said outer peripheral edge.

3. The device of claim 1, further comprising said pair of slots defining a medial section of said cutting head between said slots, said medial section of said cutting head extending between a forward section and a rearward section of said cutting head.

4. The device of claim 1, further comprising said second end of said handle being coupled to said medial section of said cutting head.

5. The device of claim 1, further comprising a base coupled to and extending upwardly from a top surface of said cutting head, said second end of said handle being coupled to and extending outwardly from said base.

6. The device of claim 5, further comprising said base having an upper surface, said upper surface being angled to extend upwardly away from said top surface of said cutting head and forwardly towards said front section of said outer peripheral edge, said second end of said handle extending from said upper surface of said base.

7. The device of claim 6, further comprising said upper surface being planar, said handle being transverse to said upper surface.

8. The device of claim 1, further comprising each of said outer front side sections extending outwardly and rearwardly from an associated side of said front section of said outer peripheral edge.

9. The device of claim 1, further comprising each of said outer rear side sections extending outwardly and forwardly from an associated side of said rear section of said outer peripheral edge.

10. A weeding hand tool device comprising:
a handle having a first end and a second end, said handle being elongated extending from said first end to said second end;
a cutting head coupled to said second end of said handle, said cutting head being planar, said cutting head having a sharpened outer peripheral edge, said outer peripheral edge comprising a front section, a pair of outer front side sections, a rear section, and a pair of outer rear side sections, said front section of said outer peripheral edge having a length greater than a length of said rear section of said outer peripheral edge, each of said outer front side sections extending outwardly and rearwardly from an associated side of said front section of said outer peripheral edge, each of said outer rear side sections extending outwardly and forwardly from an associated side of said rear section of said outer peripheral edge; and
a pair of slots extending into said cutting head, said slots being aligned and extending inwardly from opposed sides of said cutting head wherein each said slot is positioned between an associated one of said outer front side sections and an associated one of said outer rear side sections, said pair of slots defining a medial section of said cutting head between said slots, said medial section of said cutting head extending between a forward section and a rearward section of said cutting head, said second end of said handle being coupled to said medial section of said cutting head; and
a base coupled to and extending upwardly from a top surface of said cutting head, said second end of said handle being coupled to and extending outwardly from said base, said base having an upper surface, said upper surface being angled to extend upwardly away from said top surface of said cutting head and forwardly towards said front section of said outer peripheral edge, said second end of said handle extending from said upper surface of said base, said upper surface being planar, said handle being transverse to said upper surface.
